(19) United States
(12) Patent Application Publication
(10) Pub. No.: US 2010/0236068 A1
(43) Pub. Date: Sep. 23, 2010

(54) Manufacturing method of blower fan wheel

(76) Inventor: Hsiu-Yin Chen, Fengyuan City (TW)

Correspondence Address: Wang Law Firm, Inc., 4989 Peachtree Parkway,, Suite 200, Norcross, GA, 30092, US

(21) Appl. No.: 12/537,027

(22) Filed: Aug. 6, 2009

(30) Foreign Application Priority Data
Mar. 23, 2009 (TW) 098109398

(51) Int. Cl. B23P 15/04

(52) U.S. Cl. 29/889.7

(57) ABSTRACT

A manufacturing method of a blower fan wheel includes manufacturing a fixing disc having an installing ring formed and extended outwardly from the periphery of the fixing disc, arc insert slots formed on a circumferential surface of the installing ring and not intersected with the external periphery of the installing ring, and an insertion portion disposed at a central position of the fixing disc for installing a motor transmission shaft; and then inserting a vane into each insert slot by a close-packing implantation method, such that an end of each vane is passed out of each insert slot, and each vane is divided into a first side and a second side by the installing ring to produce the blower fan wheel of the present invention.

### BACKGROUND OF THE INVENTION

1. Field of the Invention

The present invention relates to a blower fan wheel, in particular to a manufacturing method of a blower fan wheel.

2. Description of the Related Art

With reference to FIG. 6 for a general conventional blower fan wheel, the blower fan wheel comprises a plurality of vanes 42 clamped and fixed between two side boards 41 and uses a riveting operation for riveting and fixing each vane 42 to each riveting portion 43 of each side board 41 between the two side boards 41. However, this method of manufacturing a blower fan wheel connects each vane 42 to each side board 41 by each riveting portion 43, and thus involves relatively more complicated manufacturing and assembling procedures and a larger number of components. As a result, the manufacturing cost of the fan wheel cannot be lowered effectively.

With reference to FIG. 7 for another conventional blower fan wheel, the blower fan wheel comprises a fixing disc 51, a vane wheel 52 and a connecting ring 53, wherein an embedding groove 511, 531 is formed separately at the periphery of the fixing disc 51 and the connecting ring 53, and the fixing disc 51 and the connecting ring 53 are connected to both sides of the vane wheel 52 through the embedding grooves 511, 531 respectively, and the roll press manufactured embedding grooves 511, 531 of the fixing disc 51 and the connecting ring 53 are provided for positioning the vane wheel 52 between the fixing disc 51 and the connecting ring 53. However, this manufacturing method of the blower fan wheel requires embedding the vane wheel 52 into each embedding groove 511, 531 of the fixing disc 51 and the connecting ring 53 first, and then using a roll press manufacture to fix the vane wheel 52 between the fixing disc 51 and the connecting ring 53. This method takes a longer manufacturing time, and still needs the process of clamping the vane wheel 52 by the fixing disc 51 and the connecting ring 53 to position the vane wheel 52, and thus the method still cannot simplify the manufacturing procedure and the structure of the blower fan wheel effectively.

With reference to FIG. 8 for another traditional fan wheel available in the market, the fan wheel comprises two frames 61, 62 installed opposite to each other, a fixing disc 63 installed between the two frames 61, 62, and a plurality of embedding grooves 64 disposed around the periphery of the fixing disc 63 and the two frames 61, 62 for embedding a plurality of vanes 65 and fixed between the two frames 61, 62. Since the structure of the fan wheel uses each embedding groove 64 for embedding each vane 65, therefore the two frames 61, 62 are provided for clamping both ends of each vane 65 to enhance the strength of each assembled vane 65, but such arrangement also cannot simplify the manufacturing procedure and the structure of the blower fan wheel to lower the manufacturing cost. Furthermore, the embedding grooves 64 are pulled, extended and deformed at the opening by a pulling force produced in a tangential position of each vane 65 during practical operations and applications of this fan wheel structure, so that the vanes 65 may be loosened from the two frames 61, 62 easily to result in an unstable air flow.

### SUMMARY OF THE INVENTION

It is a primary objective of the present invention to provide a manufacturing method of a blower fan wheel, and the method simplifies the manufacturing procedure and the structure of the blower fan wheel to lower the manufacturing cost of the fan wheel effectively.

To achieve the foregoing objectives, the present invention provides a manufacturing method of a blower fan wheel, and the method comprises the steps of: manufacturing a fixing disc having an installing ring formed and extended outwardly from the periphery of the fixing disc, a plurality of arc insert slots disposed on a circumferential surface of the installing ring and not intersected with the external periphery of the installing ring, and an insertion portion disposed at a central position of the fixing disc for installing a motor transmission shaft; preparing a plurality of vanes with the same quantity of the insert slots and a corresponding cross-sectional shape of each insert slot; and inserting each vane into each corresponding insert slot by a close-packing implantation method, such that an end of each vane is passed out of each insert slot, and each vane is divided into a first side and a second side by the installing ring, such that after all insert slots are inserted with vanes, the blower fan wheel of the present invention is produced.

### BRIEF DESCRIPTION OF THE DRAWINGS

FIG. 1 is a block diagram of a manufacturing procedure of the present invention;

FIG. 2 is a schematic view of a manufacturing procedure of the present invention;

FIG. 3 is a schematic view of an application of the present invention;

FIG. 4 is a schematic view of a manufacturing process for reinforcing a fixing condition between vanes and insert slots in accordance with the present invention;

FIG. 5 is a schematic view of another manufacturing process for reinforcing a fixing condition between vanes and insert slots in accordance with the present invention;

FIG. 6 is a perspective view of a first conventional blower fan wheel structure;

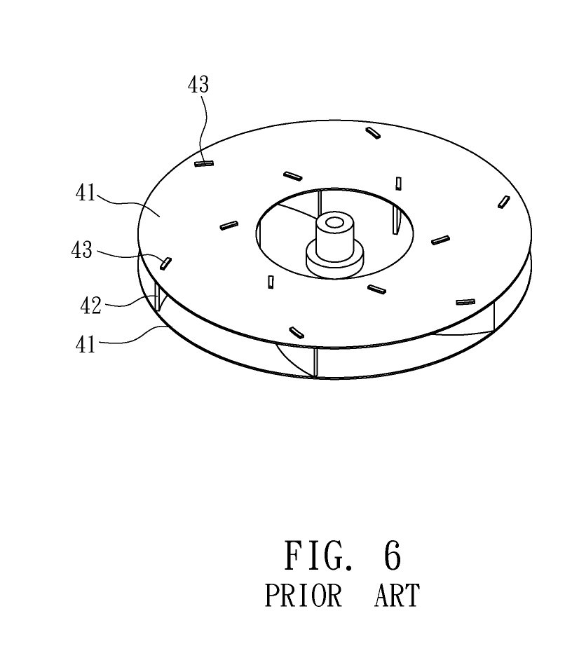

FIG. 7 is an exploded view of a second conventional blower fan wheel structure; and

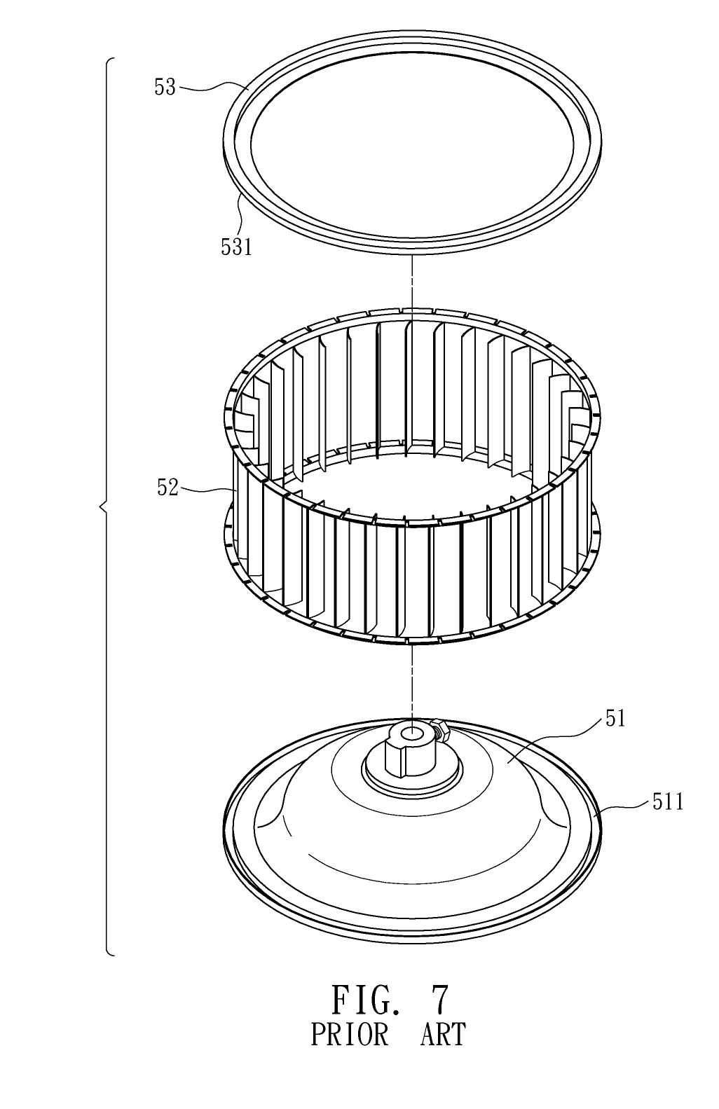

FIG. 8 is a perspective view of a third conventional blower fan wheel structure.

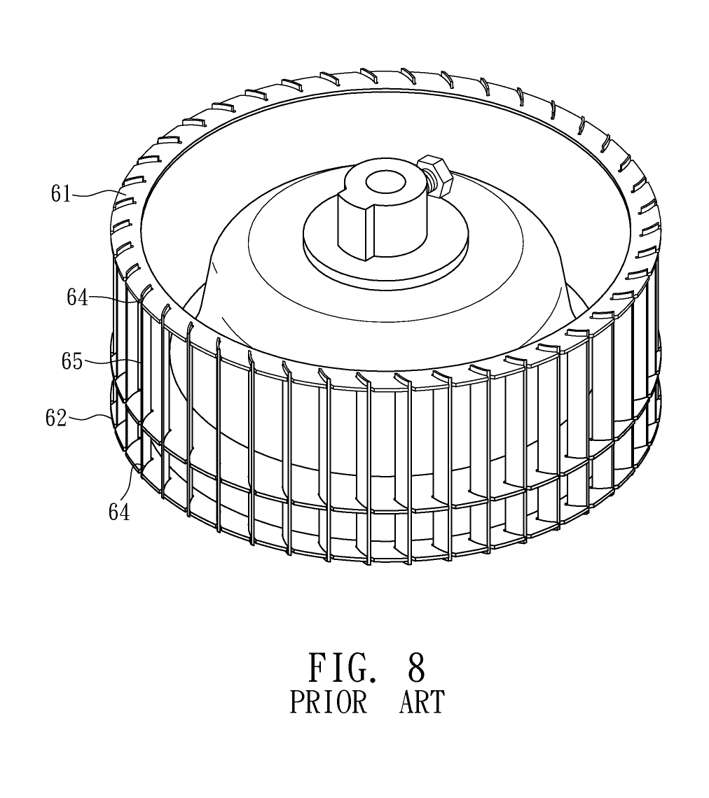

### DETAILED DESCRIPTION OF THE PREFERRED EMBODIMENTS

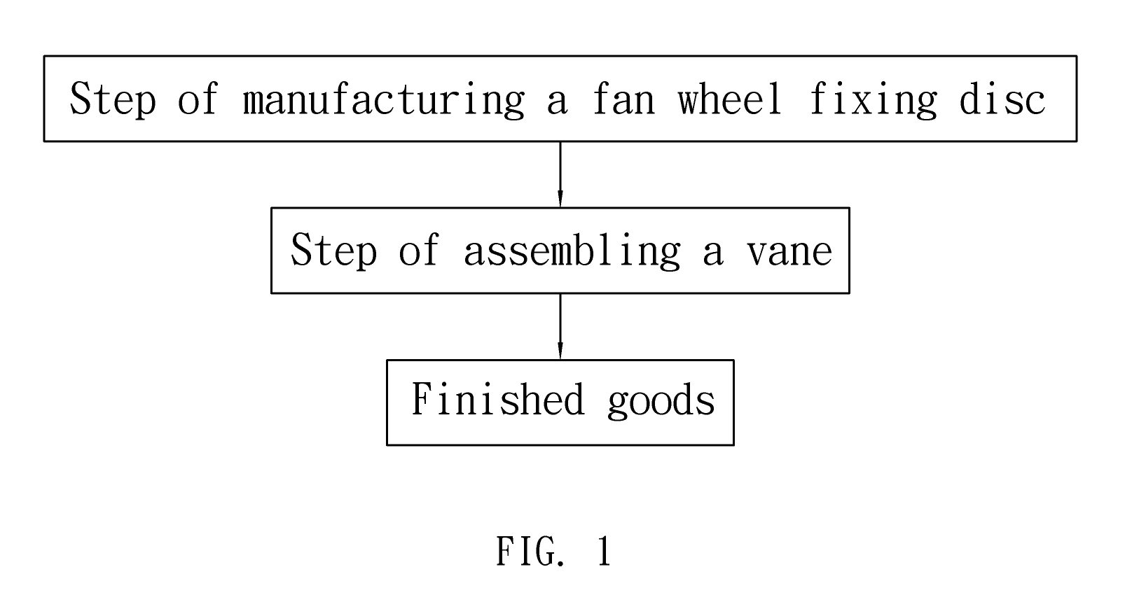

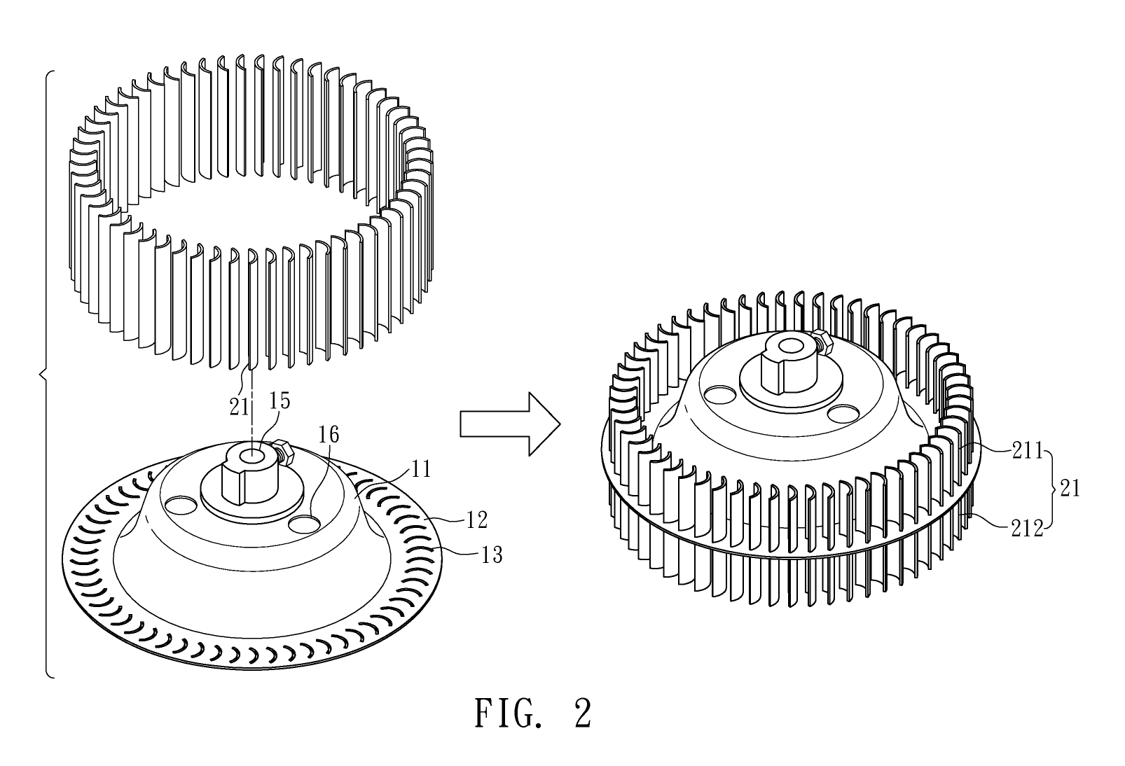

With reference to FIGS. 1 and 2 for a manufacturing method of a blower fan wheel in accordance with the present invention, the method comprises the following steps:

(a) Step of manufacturing the fan wheel fixing disc: A fixing disc 11 is manufactured, wherein an installing ring 12 is formed and extended outwardly from the periphery of the fixing disc 11, a plurality of arc insert slots 13 are formed on a circumferential surface of the installing ring 12 and not intersected with the external periphery of the installing ring 12, and an insertion portion 15 is formed at a central position of the fixing disc 11 for installing a motor transmission shaft, and at least one ventilation hole 16 is formed adjacent to the insertion portion 15.

(b) Step of assembling the vane: A plurality of vanes 21 with the same quantity of insert slots 13 and the corresponding cross-sectional shape of each insert slot 13 are prepared, and each vane 21 is inserted into each corresponding insert slot 13, such that an end of each vane 21 is passed out of each insert slot 13, and each vane 21 is divided into a first side 211 and a second side 212 by the installing ring 12, and after all insert slots 13 are inserted with vanes 21, the blower fan wheel of the present invention is produced.

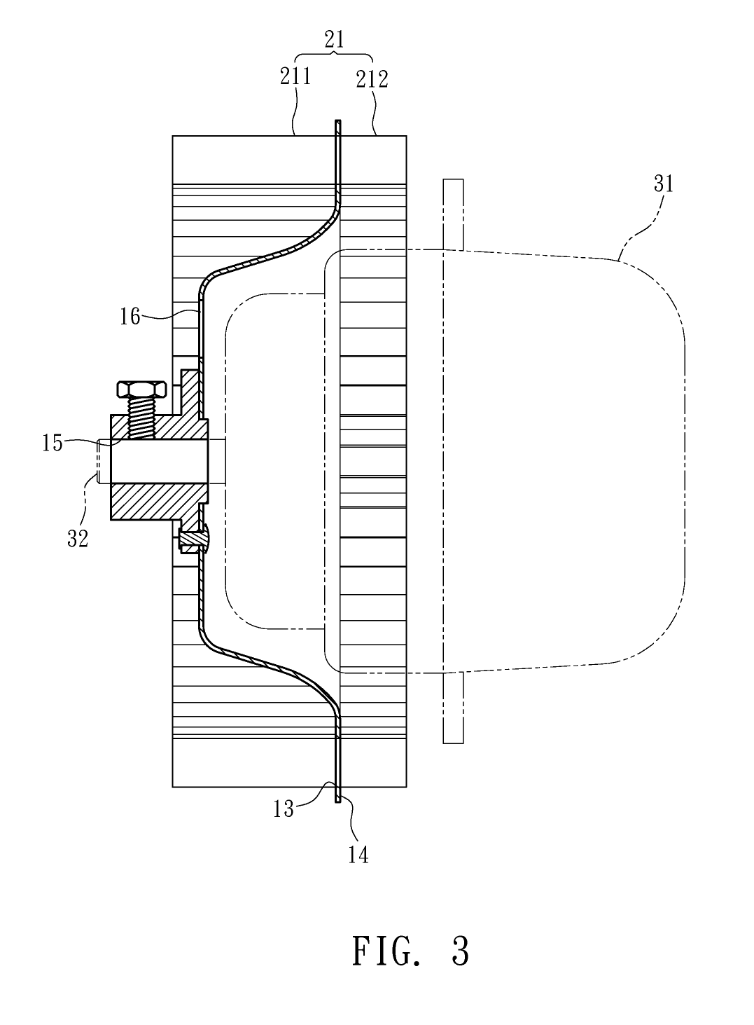

With reference to FIG. 3 for an application of the blower fan wheel manufactured in accordance with the present invention, the insertion portion 15 of the fixing disc 11 is connected to a transmission shaft 32 of a motor 31, and the first side 211 of each vane 21 of this preferred embodiment has a length greater than the length of thee second side 212 of the vane 21, such that the second side 212 of each vane 21 can be provided for an air suction of a space on an internal side of the fixing disc 11 and the same side of the motor 31, and the first side 211 of each vane 21 can be provided for an air suction of a space on an external side of the fixing disc 11. With the design of ventilation holes 16 formed on the fixing disc 11, heat produced by the operation of the motor 31 can be dissipated to the outside from each ventilation hole 16 to prevent overheats and extend the using life of the motor 31.

In a practical application of the fan wheel in accordance with the present invention, each vane 21 has an arc cross-section with a corresponding shape of the insert slot 13, such that if each vane 21 is inserted into each corresponding insert slot by a close-packing implantation method, each insert slot 13 will be covered completely, and the internal periphery of each insert slot 13 will be contacted with the external surface of each vane 21. When the fan wheel of the present invention is operated, each vane 21 is fixed and limited by a whole contact surface of each insert slot 13 to achieve the effect of preventing the installed vanes 21 from being loosened or deviated.

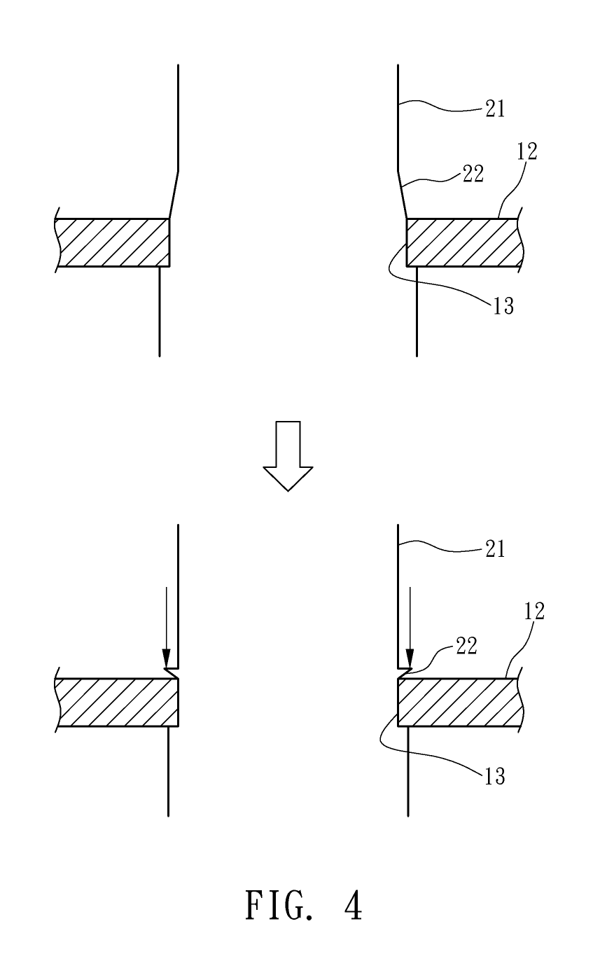

To reinforce the connection between each vane 21 and each insert slot 13, each vane 21 has a rivet section 22 formed at the external periphery of the vane 21, such that after each vane 21 is inserted into each insert slot 13 by a close-packing implantation method as shown in FIG. 4 and each vane 21 is embedded into each insert slot 13 of the installing ring 12, the rivet section 22 of each vane 21 is exposed from each insert slot 13, and a squeezing force is applied along an axial direction of each vane 21 onto the rivet section 22 of each vane 21 exposed from the insert slot 13, so that the rivet section 22 of each vane 21 can be rivetally coupled around each insert slot 13 to enhance the fixing strength between each vane 21 and each insert slot 13.

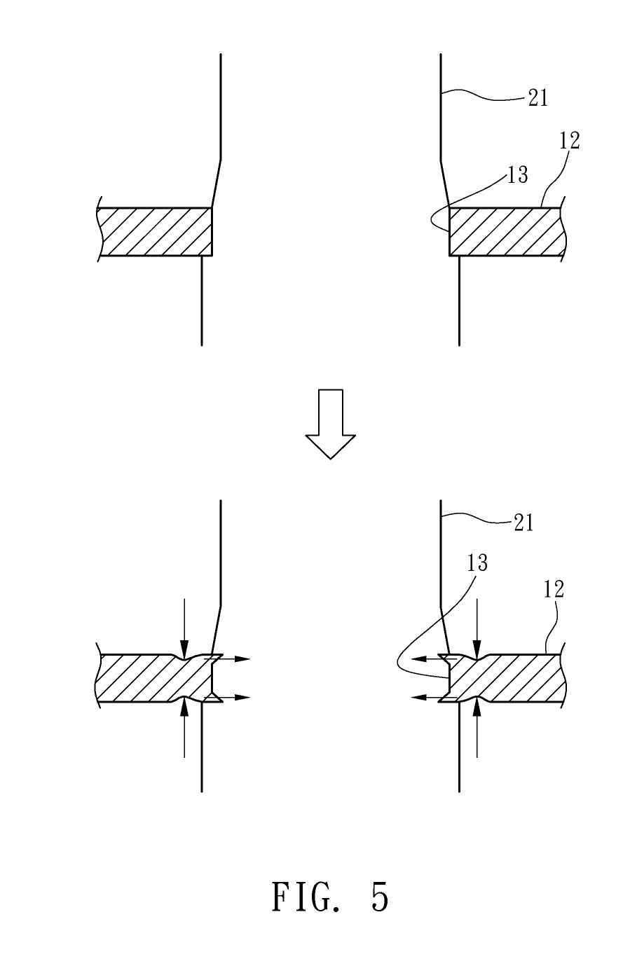

With reference to FIG. 5, after each vane 21 is inserted into each insert slot 13 by an implantation method, a squeezing force can also be applied along the axial direction of each vane 21 onto upper and lower peripheries of each insert slot 13, such that the internal periphery of each insert slot 13 can be extended transversally towards each vane 21 and embedded into each vane 21 to achieve the effect of enhancing the fixing strength between each vane 21 and each insert slot 13.

It is noteworthy to point out that after each vane 21 is inserted into each insert slot 13 by an implantation method, a squeezing force is applied along the axial direction of each vane 21 onto the rivet section 22 which is exposed from each insert slot 13 one by one, and then the squeezing force is applied along the axial direction of each vane 21 onto the upper and lower peripheries of the insert slot 13 one by one, such that each vane 21 can be rivetally coupled and embedded into the periphery of each insert slot 13 to achieve the effect of enhancing the fixing strength between each vane 21 and each insert slot 13.

The blower fan wheel manufactured by the method in accordance with the present invention has the following advantages:

1. The present invention inserts the vanes into the insert slots by an implantation method, and thus the assembled blower fan wheel has an excellent structural strength without requiring an additional frame to fix both ends of each vane, and the invention can lower the manufacturing cost of the fan wheel effectively.

2. The present invention inserts the vanes into the insert slots by an implantation method, and thus the fan wheel maintains an excellent structural strength during its operation. In other words, the invention can prevent each vane from being loosened or deviated.

3. Each vane of the present invention is divided into a first side and a second side by the fixing disc, and the second side of each vane is provided for an air suction of a space on an internal side of the fixing disc and the same side of the motor and a heat dissipation of the motor to prevent an overheat occurred during the operation of the motor, so as to extend the using life of the motor effectively.

What is claimed is:

1. A manufacturing method of a blower fan wheel, comprising the steps of:
manufacturing a fixing disc, having an installing ring formed and extended outwardly from the fixing disc, a plurality of arc insert slots disposed on a circumferential surface of the installing ring and not intersected with the external periphery of the installing ring, and an insertion portion disposed at a central position of the fixing disc for installing a motor transmission shaft; and
preparing a plurality of vanes with the same quantity of the insert slots and a corresponding cross-sectional shape of each insert slot;
inserting each vane into each corresponding insert slot by a close-packing implantation method, such that an end of each vane is passed out of each insert slot, and each vane is divided into a first side and a second side by the installing ring, such that after all insert slots are inserted with vanes, the blower fan wheel is produced.

2. The manufacturing method of a blower fan wheel as recited in claim 1, wherein the insertion portion of the fixing disc is installed onto a transmission shaft of a motor, and the vane of the first side of each vane has a length greater than the vane on the second side, and the second side of each vane is provided for an air suction of a space on an internal side of the fixing disc and the same side of motor, and the first side of each vane is provided for an air suction of a space on an external side the fixing disc.

3. The manufacturing method of a blower fan wheel as recited in claim 1, wherein the fixing disc includes at least one ventilation hole formed at a side adjacent to the insertion portion.

4. The manufacturing method of a blower fan wheel as recited in claim 1, wherein each insert slot is covered completely, and the internal periphery of each insert slot is in contact with an external surface of each vane, when each vane is embedded into each insert slot by the close-packing implantation method.

5. The manufacturing method of a blower fan wheel as recited in claim 1, wherein each vane includes a rivet section formed on an external periphery of each vane, such that when each vane is inserted into each insert slot of the installing ring by an implantation method, the rivet section of each vane is exposed from each insert slot, and a squeezing force is applied along an axial direction of each vane onto the rivet section of each vane exposed from each insert slot, such that the rivet section of each vane is rivetally coupled around each insert slot.

6. The manufacturing method of a blower fan wheel as recited in claim 1, wherein after each vane is inserted into each insert slot by a close-packing implantation method a squeezing force is applied along an axial direction of each vane onto upper and lower peripheries of each insert slot, such that the internal periphery of each insert slot is extended transversally towards each vane and embedded into each vane.

7. The manufacturing method of a blower fan wheel as recited in claim 1, wherein each vane includes a rivet section formed on an external periphery of each vane, and each vane is implanted into each insert slot by the rivet section, and a squeezing force is applied along an axial direction of each vane onto the rivet section of each vane exposed from each insert slot, and then a squeezing force is applied along an axial direction of each vane onto upper and lower peripheries of each insert slot, such that the rivet section of each vane is rivetally coupled around each insert slot.
